(19) United States
(12) Patent Application Publication
(10) Pub. No.: US 2009/0309893 A1
(43) Pub. Date: Dec. 17, 2009

(54) METHOD AND SYSTEM FOR DISPLAYING AND COMMUNICATING COMPLEX GRAPHICS FILE INFORMATION

(75) Inventors: Christopher C. Boothroyd, Vancouver (CA); Kenney Wong, Richmond (CA); Corey Auger, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: AFTERCAD SOFTWARE INC., Vancouver, BC (CA)

(21) Appl. No.: 12/306,607

(22) PCT Filed: Jun. 29, 2007
(86) PCT No.: PCT/CA07/01173

§ 371 Date: May 7, 2009

Related U.S. Application Data
(60) Provisional application No. 60/817,072, filed on Jun. 29, 2006.

(51) Int. Cl. G09G 5/00; G06F 15/16

(52) U.S. Cl. 345/581; 709/202; 709/203

(57) ABSTRACT

A method and system is disclosed which permits anyone with a web browser to view, zoom, markup, and edit CAD files without special software tools. This is accomplished by calculating and serving rasterized files in a format such as portable network graphic files that are readily viewed by a client using standard browser software.

### CROSS REFERENCE TO RELATED APPLICATION

The present application claims the benefits, under 35 U.S.C.§119(e), of U.S. Provisional Application Ser. No. 60/817,072 filed Jun. 29, 2006 entitled “Method and System for Displaying and Communicating Complex Graphics File Information” which is incorporated herein by this reference

### TECHNICAL FIELD

The invention relates to the conversion, communication and display of electronic graphics documents and in particular to transforming, conversion, communication and display of computer graphics files.

### BACKGROUND

Various computer software products are available for creating computer graphics files, such as computer-aided design or CAD files. Popular examples are AutoCAD™, Visio, Intellicad, Imagineer, Microstation and others. Files created by such programs contain complex CAD file layer information which requires the user to have a copy of the application software program to adequately view the file. Such software programs are typically expensive, complex and take considerable time to learn to use. However it is often desirable for a person who has created a CAD file to be able to send the file electronically, such as over the Internet, such that a recipient can display and manipulate the document. Currently, however the recipient will require his or her own copy of the CAD application software and be familiar with its use in order to do so. Consequently there is a need for a method to convert CAD files to a portable format which can be received and displayed using readily available software on any platform.

It is known to distribute and display maps electronically over the Internet by the map server dividing the map into sections or tiles and when a client requests an image of a location the server determines which map tile or tiles cover that location and delivers same to the client. See U.S. Pat. No. 6,724,382 Kenyon et al. and Google Inc. U.S. published patent application no. 2005/0270299 entitled “Generating and Serving Tiles in a Digital Mapping System”.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention discloses a system and method of communicating and displaying complex graphics files, comprising: a) the user selecting a graphic file to be communicated; b) rendering each layer of the graphic file to thereby form a layer raster file containing raster information for each layer and draw order information; c) converting the layer raster file to a file format which is readable by the client's browser software; and d) the client accessing a web site using internet client side browser software and requesting the converted file. According to one aspect of the invention, the graphic file is rendered by rendering each layer of said graphic file while storing the drawing order information for the data in each layer, and then sorting the data for all layers by drawing order values.

The layer raster file may comprise a field for each pixel identifying the transparency value, object identification or elevation associated with the pixel. These fields permit te method to be used in combination with map display applications to display graphics or object identification information superimposed on the maps. While the invention is described as applied to CAD files it also is useful in communicating and displaying other types of files such as GIS.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1-3 are schematic drawings illustrating the problem addressed by the invention.

FIG. 4 is a schematic diagram illustrating a system according to the invention.

FIG. 5 is a flowchart illustrating the overall method of the invention.

FIG. 6 is a flowchart illustrating the method of making a file according to the invention.

FIG. 7 is an illustration of different tools that can be provided for the client.

FIG. 8 through 19 illustrate different displays of a CAD diagram to a client.

FIG. 20 through 22 illustrate schematically an additional feature of the invention.

FIG. 23 is a screen display illustrating the display of a CAD diagram to a client in combination with a map search application.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

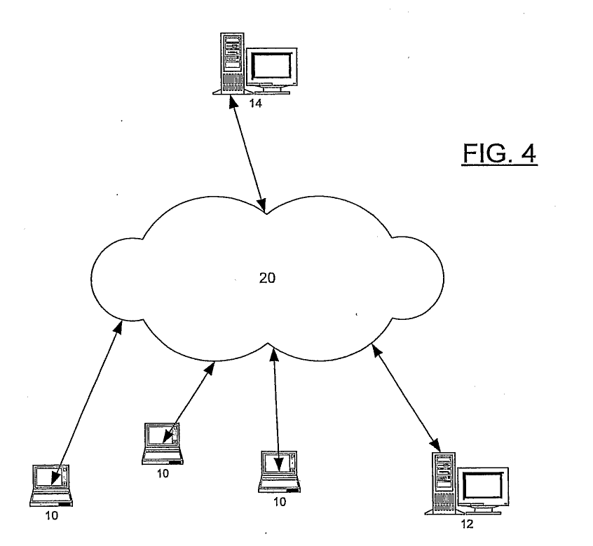

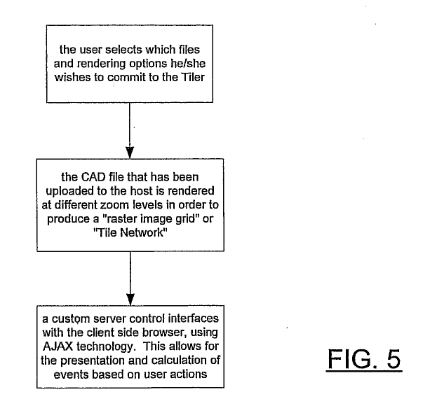

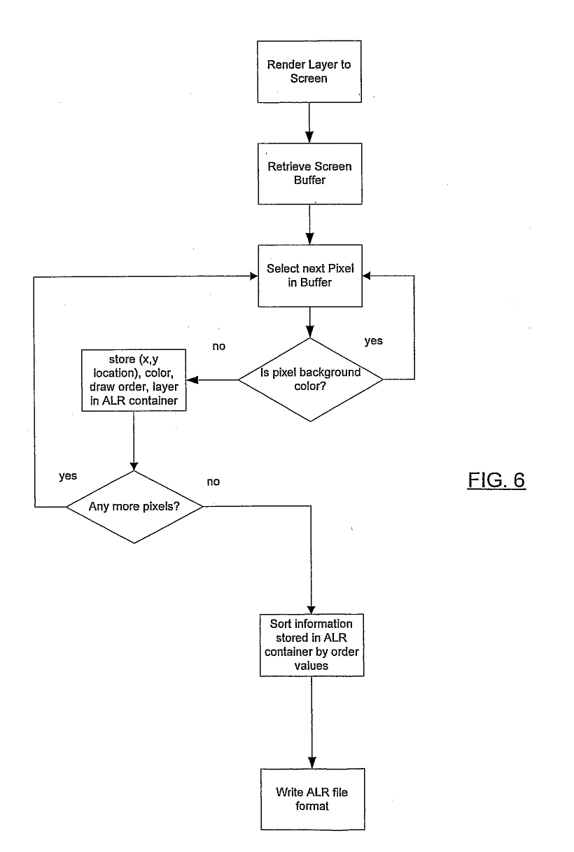

With reference to FIG. 4, a user 12 has a server accessible to the Internet 20, which has in memory CAD application software, such as AutoCAD, and one or more CAD files, such as .dwg files, which it wishes to send to clients 10 over the Internet 20 for viewing, markup and annotation. Clients 10 have standard browser software such as Internet Explorer or Firefox to access the World Wide Web but may or may not have their own CAD application software. The client 10 uses its browser software to view, mark up, annotate, pan and zoom the CAD file with full layer controls and does not need an installer, ActiveX controls or Java applets to do so.

An application service provider or host 14 has a web site accessible to user 12 and client 10 over the Internet and has the software to carry out the invention. The system permits user 12 to upload a .dwg file to the service provider 14, which is converted as described below, and then email the URL for the diagram to clients 10 who can then access the web site of service provider 14 and request and be served files in a format which can be displayed by standard browser software, such as .png files, .jpeg, .gif or .tiff. The client can also mark or annotate the files, which annotations can be saved and viewed by user 12 and clients 10.

The present process, which allows a user 12 to communicate and allow a client 10 to display, mark and annotate complex graphics files may also be carried out with the application program installed on the user's server rather than the application program being hosted on the service provider 14 server which is accessed both by the user 12 and its client 10.

The present process involves encapsulating CAD file layer information data into a custom file format that can be used to generate raster images “on the fly” to the client. This process allows a user to display raster maps in an efficient manner to the client while preserving the accuracy of the complex CAD file layer information. In addition the format will allow for “on the fly” raster transformation, that may include, but are not limited to: flip, rotate, original geometry xrefs. This following illustrates the process used to create the custom files, the file format and optimizations, and finally the process used to serve the file to the client 10.

### Layer Raster File Creation

The process generally involves three stages:
1) Data Acquisition stage: During this stage the user 12 selects which files and rendering options it wishes to commit to the application program which is operated by the service provider (referred to as “the Tiler”) and uploads the CAD file.
2) Data Preparation stage: During this stage the CAD file that has been uploaded to the service provider is rendered at different zoom levels in order to produce a “raster image grid” or “Tile Network”. This network of tiles is what the client 10 will see as final images.
3) Data Presentation stage: In this stage a custom server control interfaces with the client side browser, using AJAX technology. This allows for the presentation and calculation of events based on user actions.

Looking first at the Data Acquisition stage, the user 12 accesses the system by accessing the host's 14 web site and is served up a page to select the rendering options to be applied to the file which will be processed, such as the initial height and width of the image, the zoom factor (the percentage change of relative size of the image with each zoom step) and the number of times the zoom can be activated in one direction. Other features may also be selected, such as whether the image will have a border, whether anti-aliasing will apply, and the like. The user 12 then selects the CAD file to be processed, such as by browsing and hitting a “submit” button, thereby uploading the .dwg or other file to the service provider 14 to be converted to the necessary format as described below.

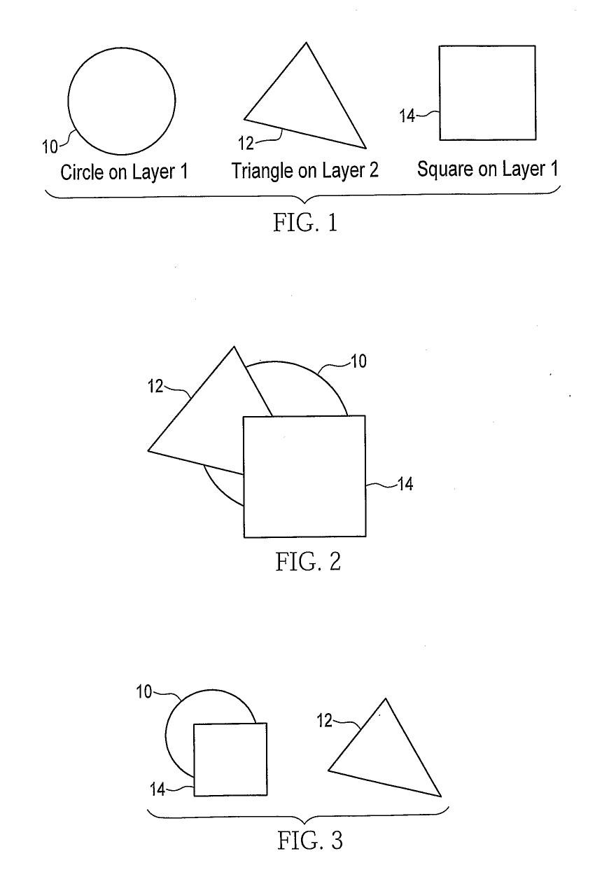

Looking next at the Data Preparation stage, typically CAD or GIS files have various layers as well as a draw order associated with different elements. One of the goals of the present invention is to provide the client 10 with a tool set to manipulate the displayed image which includes “Layer” functionality. Layer functionality is the ability to make entities that are common to a layer visible or hidden. The problem with raster images such as PNG files, is that there is no such layer support. To make the problem more complex, entities in CAD layers do not have to be the same draw order. That is to say that a layer is not like a transparent film with entities painted onto that film. Instead a layer should be viewed as a grouping of entities entirely unrelated to a concept of “layer” or “transparent film”. To better illustrate the example see FIG. 1. FIG. 1 illustrates a circle 10, triangle 12 and square 14, which were created in left to right order. Circle 10, triangle 12 and square 14 had their layers set as layers 1, 2 and 1 respectively. FIG. 2 illustrates the arrangement by the CAD program of the foregoing entities into a single scene such that they all overlap. Although the circle and square are of the same layer, they are overlapped by the triangle.

The data that is captured from the scene needs to be in association with the layers that they are on. The tile render must render once for each layer to capture the layering information. FIG. 3 shows an example of rendering first layer 1, then layer 2.

Now that one has the information is associated with layers, one still cannot simply overlay the data. Overlaying the data would cause the layers to compete for which data was in view. In addition, data that was occluded by information above it may be missed. In addition to this, if one created new elements for the portion of entities that overlap, one would be increasing the amount of data by a factorial function based on the number of layers and all possible combinations of overlap.

The foregoing problem is solved by rendering the layer while storing the drawing order information. This information is accumulated for each layer into a “Layer Raster container” structure. Once all layer data has been added to the structure, the information is sorted by the drawing order. One example of a way to gather the data is layer by layer, described as follows. The algorithm can be summed up as follows:

```
for each Layer do:
        Render Layer to Screen;
        Retrieve Screen Buffer;
        for each Pixel in Buffer do:
                If pixel is not background color:
                    store (x,y location), color, draw order, layer
                    in ALR container
        end for;
end for;
Sort information stored in ALR container by order values;
Write ALR file format;
```

Other information could at this time also be included in the Layer Raster file, information such as an XREF into original geometry set, contained in an associated Annotation layer XML file, as described below.

### ALR File Format

The format to which the Layer Raster file is stored on disk is described as follows. The Layer Raster file (referred to as the “ALR file”) is stored on disk in a format that attempts to be optimal for both size and efficiency of information retrieval. Since the encoding of data from RGB to PNG format on the fly is a factor larger then “N” where “N” is the size of bytes in the original RGB file, it is sufficient to have the information retrieval process take “N” or less steps without increasing the overall runtime, that is, the minimum time it would take to scan through “N” items is “N”. One needs to determine information about these “N” items that are scattered through the ALR file and possibly on “M” layers. The question now becomes the complexity of asking “M” questions about “N” items.

Pixel data from the original Screen buffer is encoded into a “Packet” of information. The information that is required is: the x and y location of the color data in the new raster, the layer that the pixel belongs to and the color of that pixel. This data is encoded in one way as follows (there could be any number of bits) as follows.

| X | Y | layer | color |
|---|---|---|---|
| 16 bits | 16 bits | 32 bits | 32 bits |

This storage allows for X to range from 0-65536 and Y to range from 0-65536 as well as full support for RGBA 32 bit color. This initial format has been optimized based on the knowledge that these packets tend to order themselves in medium to large sequences of packets of the same layer. So the format changed with an initial packet to indicate the layer and the number indicating the number of packet data following, that is of the same layer. This has the result of reducing the file size by ⅓.

| layer | #in layer | X | Y | color | X | Y | color | etc . . . |
|---|---|---|---|---|---|---|---|---|
| 39 | 126 | 85 | 12 | 1589 | 86 | 12 | 1589 | . . . |

The 32 bit layer value has also taken on a special meaning in order to do fast calculations based on its value. In CAD documents it is not uncommon to have more than 200 layers. Which layers are on or off is determined by doing a bitwise masking compare. (The mask is shown as value 0 for layers “off” but it could also be value 0 for layers “on”).

| layer # | 1 | 2 | 3 |
|---|---|---|---|
| mask | 0 | 1 | 0 |
| pixel layer | 0 | 0 | 1 |
| Result | 0 | 0 | 0 |

In the example above the mask indicates that only layer 2 is on. This information is compared with a pixel that is on layer 3 however. The result is that no pixel information will be drawn. This bitwise compare works well but there are only have 32 bits for the layer info. This means that only 32 layers can be represented. To get around this, the first 16 bits are used to represent a plane or dimension for the next 16 bits to be a mask on. The result is that one can now have 65536×16 layers. So, for example, if a pixel is on layer 44 it would be encoded in the following manner.

Integer(44/16)=2

So one knows that one is on the second plane.

44−(2*16)=12

So the information is encoded in the following way

| 16 bits | 16 bits |
|---|---|
| 2 | 12 bit on |
| 0000000000000010 | 0001000000000000 |

This allows on the decoding phase to decode layering information with an array lookup for “dimension” and then a bitwise mask test on the resulting 16 bits. The final format of the file including header information is included below for clarity. Since the layer information has been accumulated with a draw order to sort on, the final format is already in order.

| Size | Purpose | Example |
|---|---|---|
| 4 bytes | File Identifier | ‘ACLR’ |
| 4 bytes | # Layers | 45 |
| 4 bytes | Background Color | 0 |
| 4 bytes | Image Width | 250 |
| 4 bytes | Image Height | 250 |
| 4 bytes | Layer Dimensions | 16 |
| 4 bytes | # of Packets | 652349 |
| 2 bytes | X location | 35 |
| 2 bytes | Y location | 201 |
| 4 bytes | Color | 1458 |
| 4 bytes | Layer | 1 |
| 4 bytes | # preceding pixels on layer | 584 |
| 2 bytes | X location | 36 |
| 2 bytes | Y location | 201 |
| 4 bytes | Color | 1458 |
| 2 bytes | X location | 37 |
| 2 bytes | Y location | 201 |

### File Serving

Since the client 10 does not recognize this ALR file format, it must be converted into a universally accepted format that can be digested by the client's browser. The preferred format to serve to the client is PNG (portable network graphic), but other formats such as JPEG or GIF formats are also suitable. Clients make requests for ALR files that includes the information about which layers are turned off. This information is encoded in a GET request, to take advantage of proxy and gateway caching functionality. An example request from the client with layers 17, 24 and 35 turned off would look like the following (where the host's URL is www.aftercad.com).

http://www.aftercad.com/x0y1z3.alr?a=17-24-35

This request will come into the server where a custom request handler for files of .alr extension has been registered. The request above would evoke the custom handler. The handler would then be able to decode the GET request into layers masks that represented the ‘off’ layers. The requested ALR file is read into memory and the pixels are processed according to the layer information that was provided. Once processing of the ALR file is complete, the caching headers and Mime types are set and the newly encoded PNG file streamed back to the client. The result is a PNG raster image with the layers the client requested to be turned off not present in the image.

To reduce processing time, only the tile portions of the drawing which are viewable by the client are served up, in a manner as utilized in other existing tiling applications.

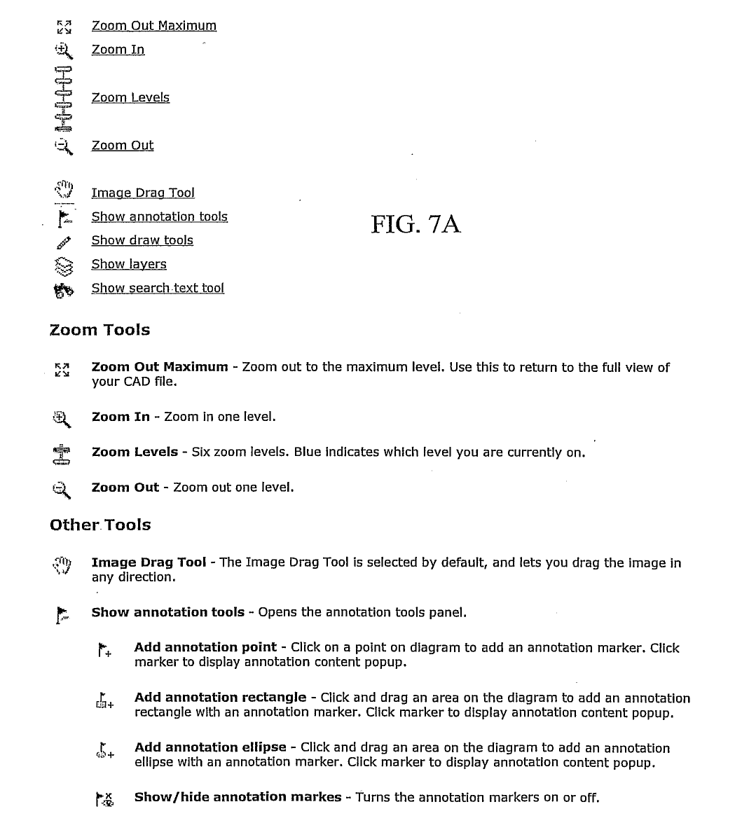

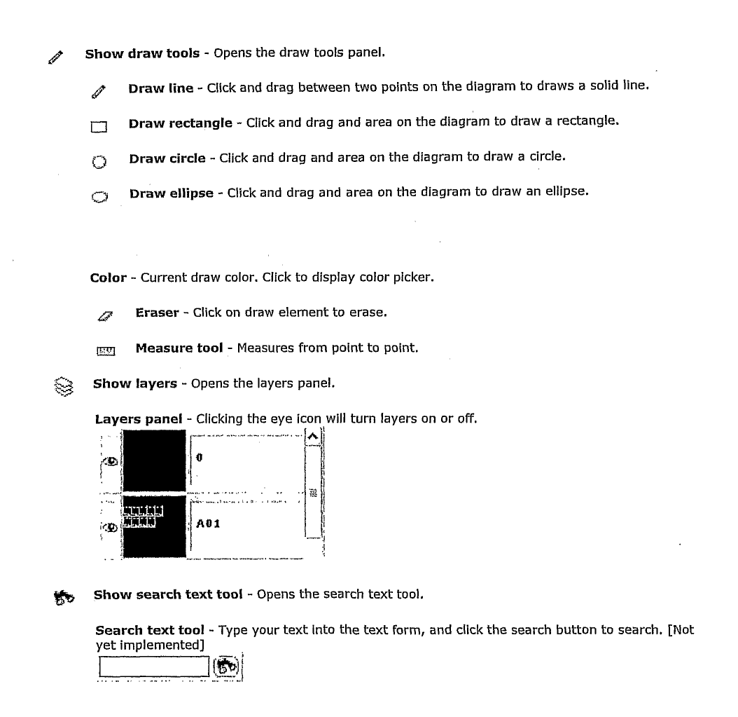

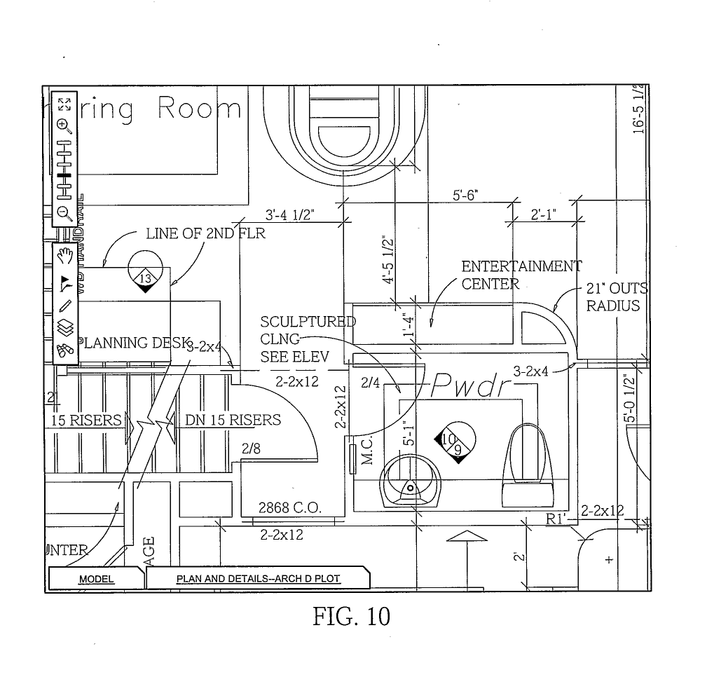

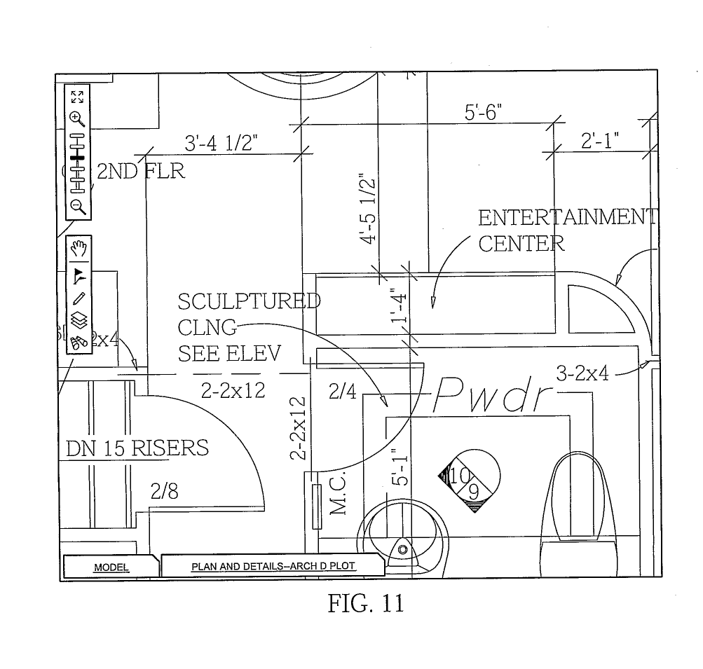

With respect to the data presentation stage, FIG. 7-19 are illustrations showing how the CAD diagram can be served up to the client 10 after the client 10 has received the URL for the diagram from the user 12 and accesses the web site with its browser. FIG. 7 illustrates different tools that can be provided for the client. Once the ALR file has been created by the host server and given a file name, the user 12 can request to be served up the file from the host web site, with accompanying tools, as shown in FIG. 7. The annotation and draw tools utilize an Annotation XML file which is associated with the ALR file and will be described in further detail below. The user 12 can then copy the file's URL, or be prompted to have it copied for it, and forward the URL by email to the client 10. Either the client 10 or the user 12 can use a browser to display and annotate the diagram.

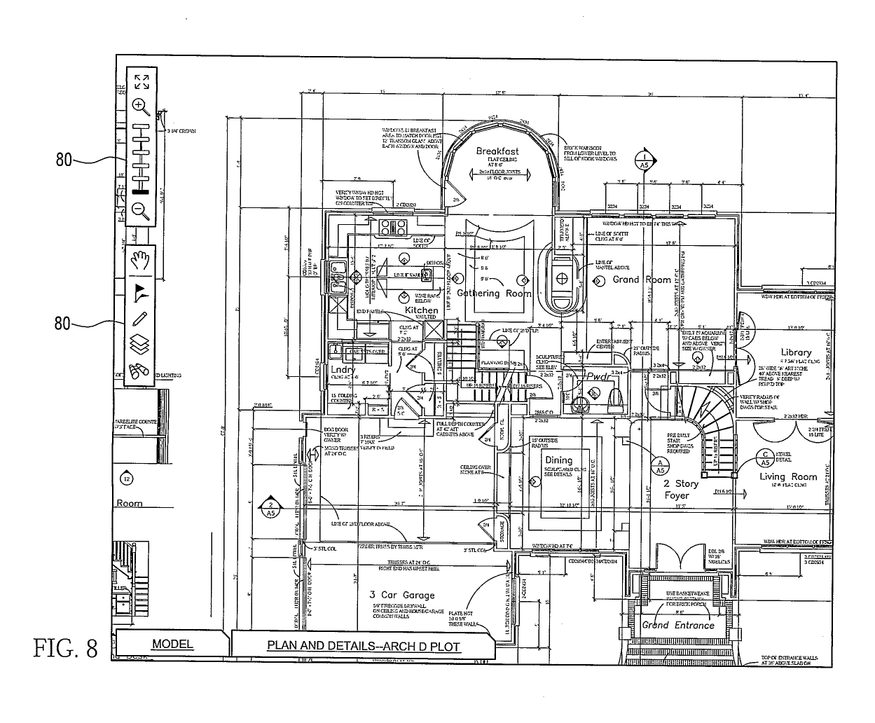

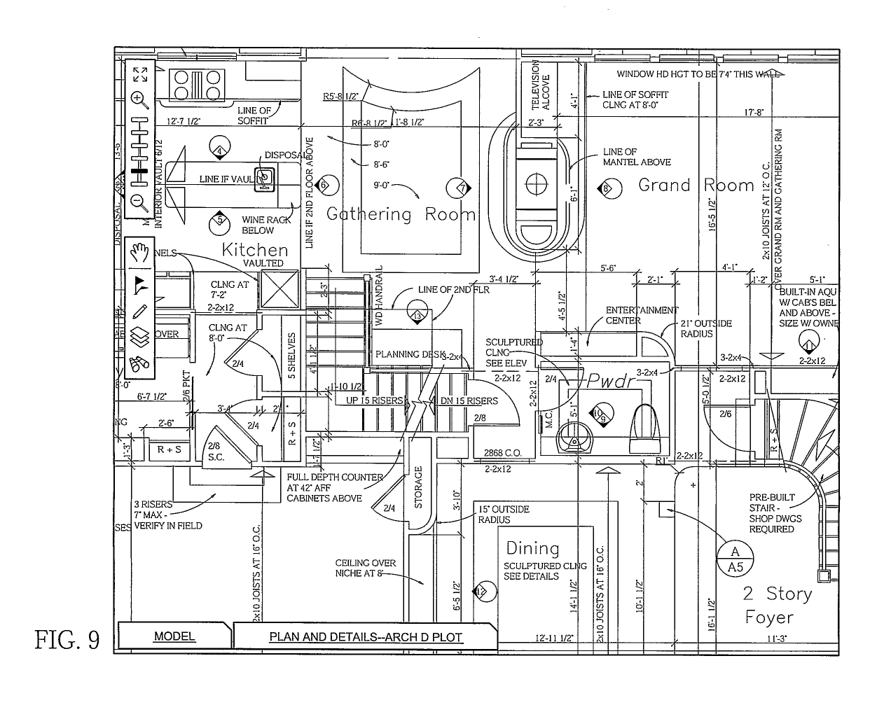

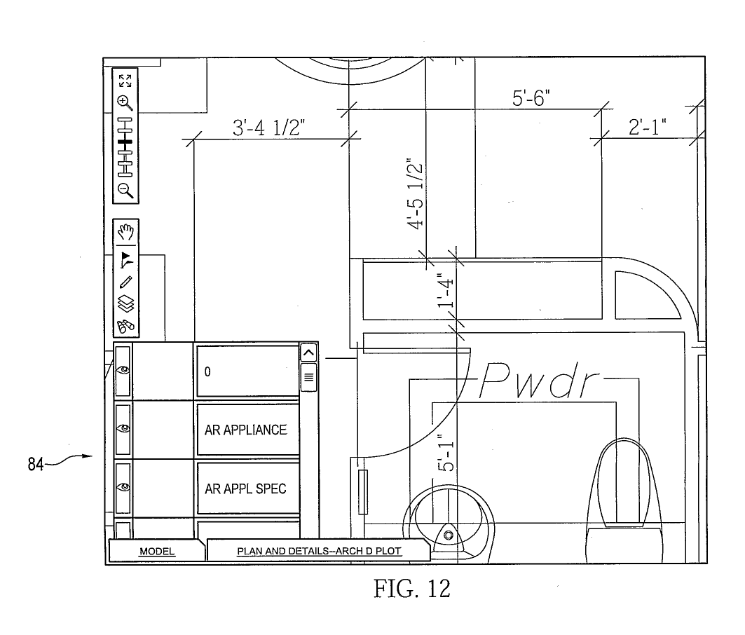

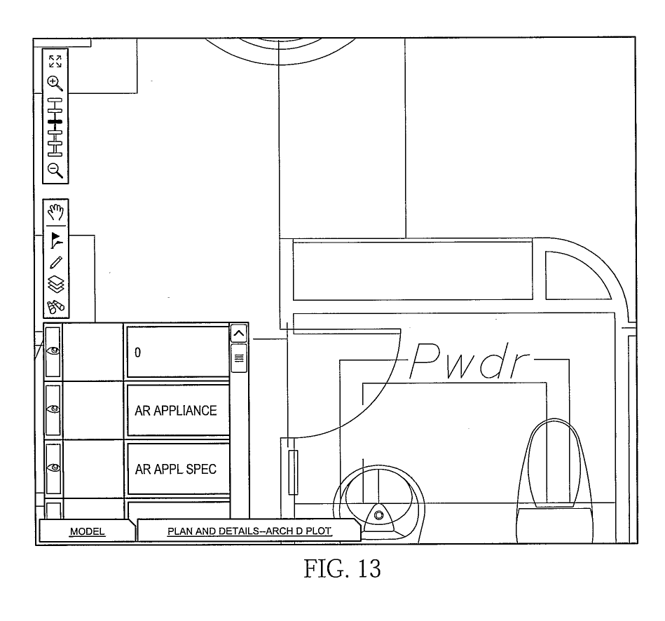

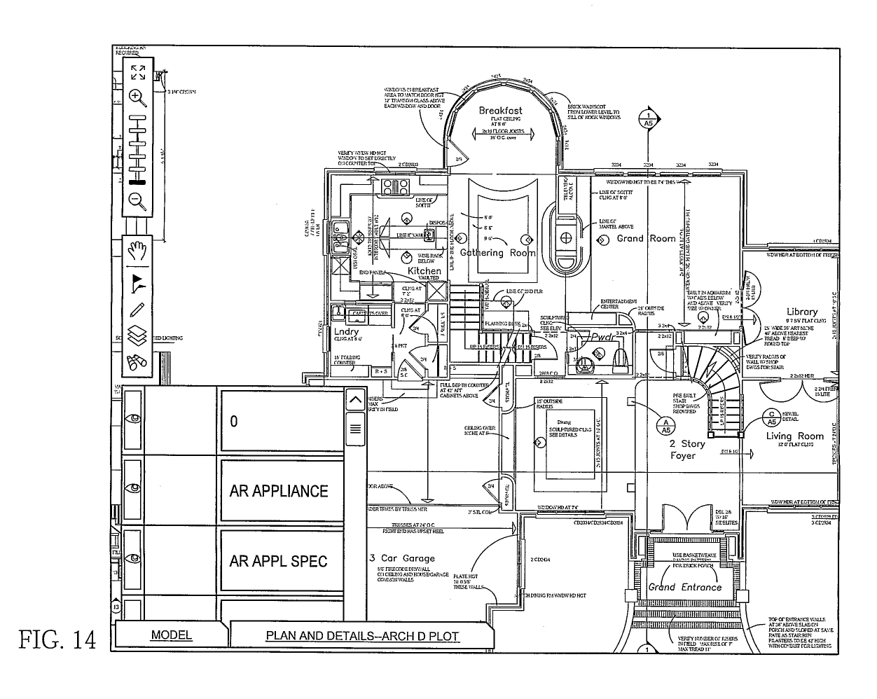

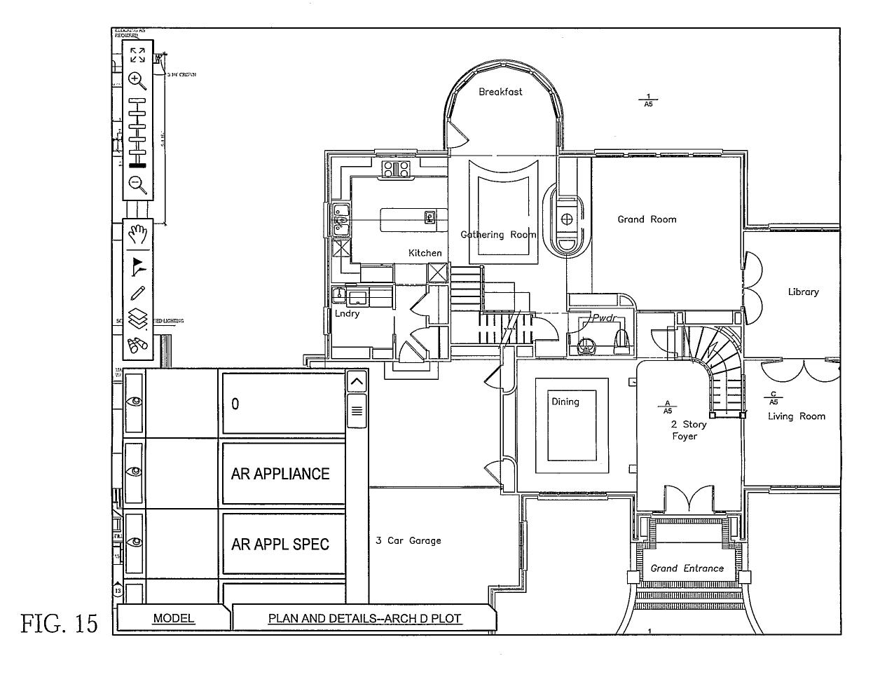

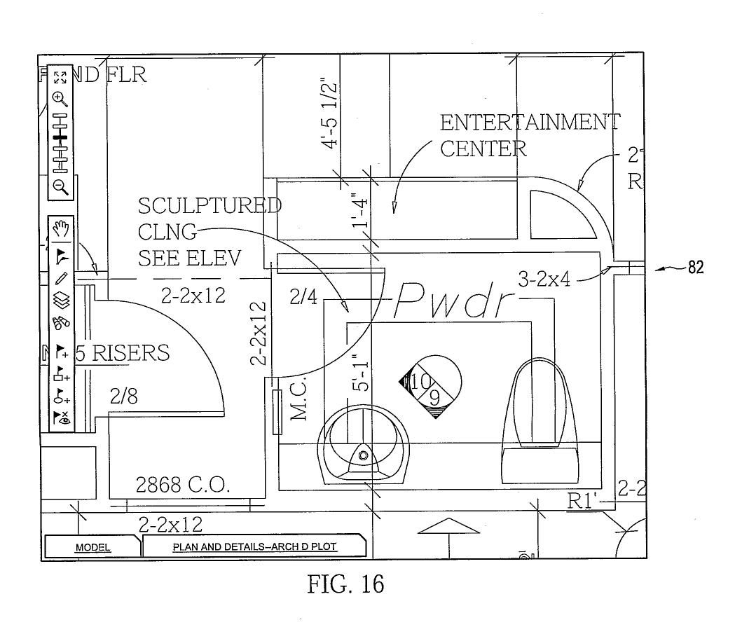

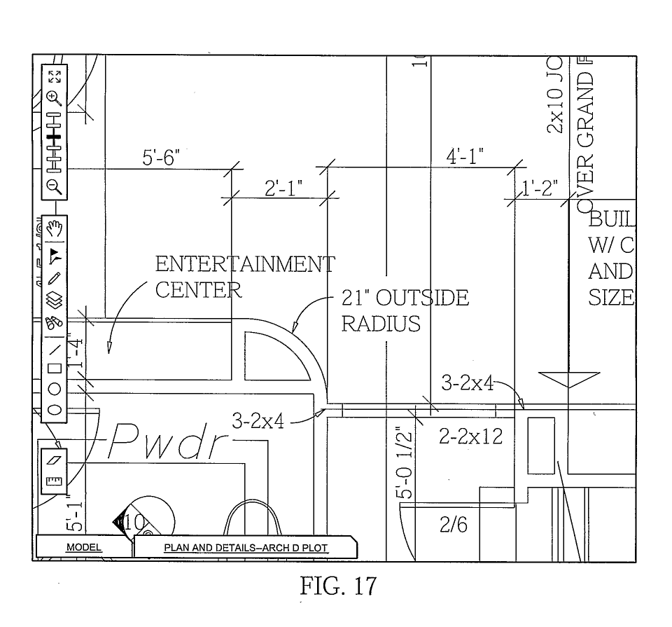

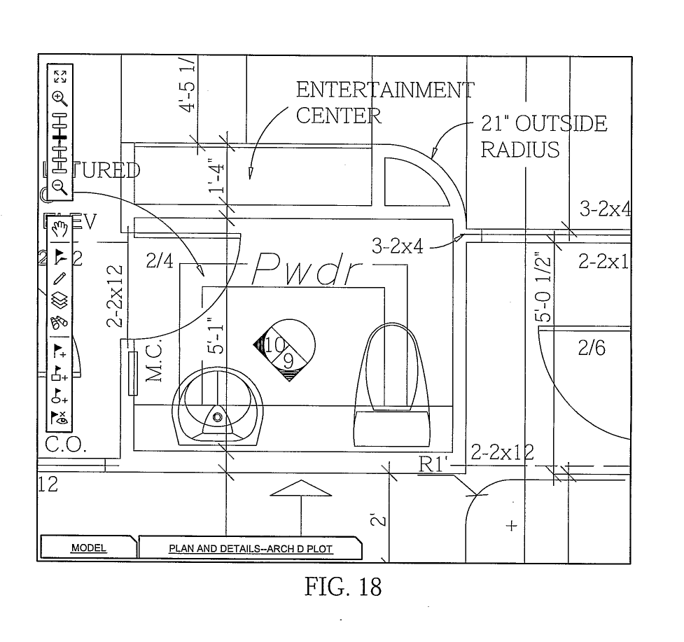

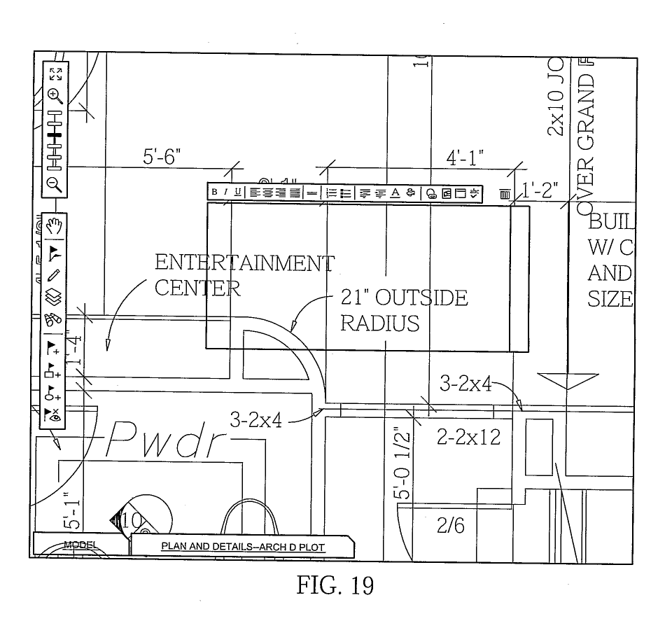

FIG. 8 shows the CAD diagram as served up to the client 10, displaying toolbar 80 and showing all layers. By clicking on the zoom tool the client can successively zoom the diagram image as shown through FIGS. 9, 10 and 11. In FIGS. 12 and 13 the client clicks on the layers tool, which displays thumbnail images of each isolated layer along with buttons at 84 by clicking on which the layer can be removed. In FIGS. 14 and 15 a number of layers are successively removed from the full size diagram. FIG. 17 illustrates the tool bar for the draw tools and FIG. 18 illustrates the tool bar for the annotation tools. The client can place an annotation marker 82 on a point or an elliptical or rectangular area as shown in FIG. 16 and clicking on the marker brings up a box in which the client can type and edit text, shown in FIG. 19.

### Annotation Layer XML File Description

The Annotation layer XML File serves the following purposes:
1. To hold non-geometric metadata pertaining to a CAD file. Such metadata includes, but is not limited to: a. general file metadata (title, author, keywords, etc); b. layer metadata.
2. To hold CAD rendered image metadata. This refers to rendered images that exist as thumbnail images, and ALR tiled image, and other future rendered images. Metadata includes, but is not limited to: a. Rendered images dimensions; b. Number of zoom levels of rendered images.
3. To hold geometric data originally extracted from the CAD file and geometry in addition to that originally extracted from the CAD file. Such data includes, but is not limited to: a. Geometry type (lines, rectangles, ellipses); b. Geometry coordinates.
4. To hold annotation data as created by the application. Such data includes, but is not limited to: a. Annotation type (point, rectangle, ellipse); b. Textual content.
5. The system can set and define various levels of access for adding, editing, deleting annotations.
6. Tools such as a symbols library can be used to facilitate the making of annotations, such as by dragging a symbol from the symbols library.

### The Annotation Layer XML File Format

Each CAD file rendered and uploaded to the server will have an Annotation layer XML File file associated with it. This file will contain the following data:

A) CAD File Metadata; This includes:
objectDbHandle—to access through DWGDirect DB layer
sourceFile (this metadata is embedded within AutoCAD file), such as:
   tileName—original source file name
   title
   subject
   author
   keywords
   comments
   hyperlink base
   createdDate
   lastModifiedDate
   file size (bytes)
   units—CAD units used (m, ft, km, mm, etc)—
   custom fields (v2)
      B) Rendered Image Metadata, such as:
width & height in pixels
tile width & height
number of zoom levels
zoom factor
units-per-pixel
CAD origin in pixels
   C) Layer Metadata, such as:
layerDbHandle—to access through DWGDirect DB layer
name
visibility—On, Off, Frozen
   D) Annotation Data, such as:
annotation type
   rectangle annotation:
top-left x, y & width/height in CAD coords
   oval annotation:
centre x, y & width/height in CAD coords
   point annotation:
x, y in CAD coords
annotation text
   E) AfterCAD Geometry Data, such as
geom id
geom type (line, rect, ellipse):
   line geom:

x1, y1, x2, y2 in CAD coords
strokecolor
   rect geom:
top-left x, y & width/height in CAD coords
strokecolor
isfilled/fillcolor
   ellipse geom:
top-left x, y & width/height in CAD coords
strokecolor
isfilled/fillcolor

The following is an example of an Annotation layer XML File:

```
<?xml version=“1.0” encoding=“utf-8”?>
<CADXML>
  <Header ModificationDate=“Thu May 18 00:23:04 2006” CreationDate=“Sat Mar 08
11:58:19 2003”
    Units=“unitless” HyperLinkBase=““”” DWGVersion=“AC1018” File-
Name=“SAN.dwg”/>
  <SmartLayerSummary AccessTime=“Wed May 31 16:30:17 2006” Author=“” Comments=“”
    CreationTime=“Tue May 23 23:24:11 2006” FileSize=“2246584” HyperLinkBase=-
“” Keywords=“”
    LastSavedBy=“” ModificationTime=“Wed May 17 23:23:04 2006”
RevisionNumber=“” Subject=“”
    Title=“”/>
  <LayerTable>
  <LayerTableRecord Name=“0” IsOn=“true” IsFrozen=“false” IsLocked=“false”/>
  <LayerTableRecord Name=“FeatureAttribs” IsOn=“false” IsFrozen=“false”
IsLocked=“false”/>
  <LayerTableRecord Name=“Unknown_Area_Type” IsOn=“false” IsFrozen=“false”
IsLocked=“false”/>
  <LayerTableRecord Name=“STATE_PARK_RECREATION_AREA_ARBO”
IsOn=“false” IsFrozen=“false” IsLocked=“false”/>
  <LayerTableRecord Name=“MILITARY_RESERVATION” IsOn=“true”
IsFrozen=“false” IsLocked=“false”/>
  <LayerTableRecord Name=“NATIONAL_PARK_MONUMENT_LAKESHOR”
IsOn=“false” IsFrozen=“false” IsLocked=“false”/>
  <LayerTableRecord Name=“SMALL_PARK” IsOn=“true” IsFrozen=“false”
IsLocked=“false”/>
  <LayerTableRecord Name=“Unclassified_Line_Feature” IsOn=“false”
IsFrozen=“false” IsLocked=“false”/>
  <LayerTableRecord Name=“STATE_WILDLIFE_REFUGE_GAME_PRES”
IsOn=“false” IsFrozen=“false” IsLocked=“false”/>
  <LayerTableRecord Name=“LARGE_PARK” IsOn=“true” IsFrozen=“false”
IsLocked=“false”/>
  <LayerTableRecord Name=“LAND_GRANT” IsOn=“false” IsFrozen=“false”
IsLocked=“false”/>
  <LayerTableRecord Name=“APPROXIMATE_BOUNDARY” IsOn=“false”
IsFrozen=“false” IsLocked=“false”/>
  <LayerTableRecord Name=“MONUMENTED_POINT_ON_A_BOUNDARY”
IsOn=“false” IsFrozen=“false” IsLocked=“false”/>
  <LayerTableRecord Name=“BAYS_ESTUARIES_GULFS_OCEANS_SEA”
IsOn=“true” IsFrozen=“false” IsLocked=“false”/>
  <LayerTableRecord Name=“LAKE_OR_POND” IsOn=“true” IsFrozen=“false”
IsLocked=“false”/>
  <LayerTableRecord Name=“OBSTRUCTION_AREA_IN_WATER_AREA”
IsOn=“false” IsFrozen=“false” IsLocked=“false”/>
  <LayerTableRecord Name=“FLATS_TIDAL_MUD_SAND_GRAVEL_” IsOn=“true”
IsFrozen=“false” IsLocked=“false”/>
  <LayerTableRecord Name=“RESERVOIR” IsOn=“false” IsFrozen=“false”
IsLocked=“false”/>
  <LayerTableRecord Name=“RESERVOIR_COVERED” IsOn=“false”
IsFrozen=“false” IsLocked=“false”/>
  <LayerTableRecord Name=“SHORELINE” IsOn=“false” IsFrozen=“false”
IsLocked=“false”/>
  <LayerTableRecord Name=“MANMADE_SHORELINE” IsOn=“true”
IsFrozen=“false” IsLocked=“false”/>
  <LayerTableRecord Name=“CLOSURE_LINE” IsOn=“false” IsFrozen=“false”
IsLocked=“false”/>
  <LayerTableRecord Name=“PROCESSING_LINE” IsOn=“false” IsFrozen=“false”
IsLocked=“false”/>
  <LayerTableRecord Name=“Intermittent_Stream_or_River” IsOn=“true”
IsFrozen=“false” IsLocked=“false”/>
  <LayerTableRecord Name=“STREAM” IsOn=“true” IsFrozen=“false”
IsLocked=“false”/>
  <LayerTableRecord Name=“ROCK” IsOn=“false” IsFrozen=“false”
IsLocked=“false”/>
  <LayerTableRecord Name=“UPPER_ORIGIN_OF_STREAM” IsOn=“false”
IsFrozen=“false” IsLocked=“false”/>
  <LayerTableRecord Name=“STREAM_ENTERING_WATER_BODY” IsOn=“false”
IsFrozen=“false” IsLocked=“false”/>
  <LayerTableRecord Name=“UPPER_ORIGIN_OF_STREAM_AT_WATER”
IsOn=“false” IsFrozen=“false” IsLocked=“false”/>
  <LayerTableRecord Name=“CHANNEL_IN_WATER_AREA” IsOn=“false”
IsFrozen=“false” IsLocked=“false”/>
  <LayerTableRecord Name=“APPARENT_LIMIT” IsOn=“false” IsFrozen=“false”
IsLocked=“false”/>
  <LayerTableRecord Name=“Unknown_Point_Feature” IsOn=“false” IsFrozen=“false”
IsLocked=“false”/>
  <LayerTableRecord Name=“INTERMEDIATE_CONTOUR” IsOn=“false”
IsFrozen=“false” IsLocked=“false”/>
  <LayerTableRecord Name=“INDEX_CONTOUR” IsOn=“false” IsFrozen=“false”
IsLocked=“false”/>
  <LayerTableRecord Name=“CARRYING_CONTOUR” IsOn=“false” IsFrozen=“false”
IsLocked=“false”/>
  <LayerTableRecord Name=“SPOT_ELEVATION_LESS_THAN_3RD_OR”
IsOn=“false” IsFrozen=“false” IsLocked=“false”/>
  <LayerTableRecord Name=“UNSURVEYED_AREA” IsOn=“false” IsFrozen=“false”
IsLocked=“false”/>
  <LayerTableRecord Name=“ARBITRARY_CLOSURE_LINE” IsOn=“false”
IsFrozen=“false” IsLocked=“false”/>
  <LayerTableRecord Name=“POINT_ON_SECTION_LINE_NO_CORNER”
IsOn=“false” IsFrozen=“false” IsLocked=“false”/>
  <LayerTableRecord Name=“HELIPORT_PERIMETER_OF_HELIPORT”
IsOn=“false” IsFrozen=“false” IsLocked=“false”/>
  <LayerTableRecord Name=“POWER_TRANSMISSION_LINE” IsOn=“false”
IsFrozen=“false” IsLocked=“false”/>
  <LayerTableRecord Name=“ROAD_OR_STREET_CLASS_3” IsOn=“true”
IsFrozen=“false” IsLocked=“false”/>
  <LayerTableRecord Name=“SECONDARY_ROUTE_CLASS_2_SYMBOL_”
IsOn=“true” IsFrozen=“false” IsLocked=“false”/>
  <LayerTableRecord Name=“TRAIL_CLASS_5_OTHER_THAN_FOUR-W”
IsOn=“true” IsFrozen=“false” IsLocked=“false”/>
  <LayerTableRecord Name=“ROAD_OR_STREET_CLASS_4” IsOn=“true”
IsFrozen=“false” IsLocked=“false”/>
  <LayerTableRecord Name=“PRIMARY_ROUTE_CLASS_1_SYMBOL_UN”
IsOn=“true” IsFrozen=“false” IsLocked=“false”/>
  <LayerTableRecord Name=“CLOVERLEAF_OR_INTERCHANGE” IsOn=“true”
IsFrozen=“false” IsLocked=“false”/>
  <LayerTableRecord Name=“PRIMARY_ROUTE_CLASS_1_DIVIDED_L”
IsOn=“true” IsFrozen=“false” IsLocked=“false”/>
  <LayerTableRecord Name=“TOLL_GATE_TOLL_PLAZA_OR_PERIMET”
IsOn=“false” IsFrozen=“false” IsLocked=“false”/>
  <LayerTableRecord Name=“ROAD_OR_STREET_CLASS_3_DIVIDED_”
IsOn=“true” IsFrozen=“false” IsLocked=“false”/>
  <LayerTableRecord Name=“PRIMARY_ROUTE_CLASS_1_SYMBOL_DI”
IsOn=“true” IsFrozen=“false” IsLocked=“false”/>
  <LayerTableRecord Name=“FOOTBRIDGE” IsOn=“false” IsFrozen=“false”
IsLocked=“false”/>
  <LayerTableRecord Name=“CUL-DE-SAC” IsOn=“false” IsFrozen=“false”
IsLocked=“false”/>
  <LayerTableRecord Name=“TUNNEL_PORTAL” IsOn=“false” IsFrozen=“false”
IsLocked=“false”/>
  <LayerTableRecord Name=“BRIDGE_ABUTEMENT” IsOn=“false” IsFrozen=“false”
IsLocked=“false”/>
  <LayerTableRecord Name=“DRAWBRIDGE” IsOn=“false” IsFrozen=“false”
IsLocked=“false”/>
  <LayerTableRecord Name=“CARLINE” IsOn=“false” IsFrozen=“false”
IsLocked=“false”/>
  <LayerTableRecord Name=“RAILROAD” IsOn=“true” IsFrozen=“false”
IsLocked=“false”/>
  <LayerTableRecord Name=“RAILROAD_SIDING” IsOn=“false” IsFrozen=“false”
IsLocked=“false”/>
  <LayerTableRecord Name=“LANDING_STRIP_AIRPORT_PERIMITER”
IsOn=“false” IsFrozen=“false” IsLocked=“false”/>
  <LayerTableRecord Name=“ROAD_OR_STREET_CLASS_3_SYMBOL_D”
IsOn=“true” IsFrozen=“false” IsLocked=“false”/>
  <LayerTableRecord Name=“NONSTANDARD_SECTION_OF ROAD” IsOn=“false”
IsFrozen=“false” IsLocked=“false”/>
  <LayerTableRecord Name=“PERIMITER_OF_PARKING_AREA” IsOn=“false”
IsFrozen=“false” IsLocked=“false”/>
  <LayerTableRecord Name=“ROAD_IN_TRANSITION” IsOn=“false”
IsFrozen=“false” IsLocked=“false”/>
  <LayerTableRecord Name=“DEAD_END” IsOn=“false” IsFrozen=“false”
IsLocked=“false”/>
  <LayerTableRecord Name=“RAILROAD_IN_STREET_OR_ROAD” IsOn=“false”
IsFrozen=“false” IsLocked=“false”/>
  <LayerTableRecord Name=“TURNTABLE” IsOn=“false” IsFrozen=“false”
IsLocked=“false”/>
  <LayerTableRecord Name=“FERRY_CROSSING” IsOn=“false” IsFrozen=“false”
IsLocked=“false”/>
  <LayerTableRecord Name=“PERIMETER_OR_LIMIT_OF_YARD” IsOn=“false”
IsFrozen=“false” IsLocked=“false”/>
  <LayerTableRecord Name=“COG_RAILROAD_INCLINE_RAILWAY_LO”
IsOn=“false” IsFrozen=“false” IsLocked=“false”/>
  <LayerTableRecord Name=“RAILROAD_STATION_PERIMETER_OF_S”
IsOn=“false” IsFrozen=“false” IsLocked=“false”/>
  </LayerTable>
  <LayoutSet>
  <Layout Name=“Model” Space=“Model”>
    <TileSet ZoomLevels=“2”>
    <TileLevel Height=“0” OriginX=“0” OriginY=“0” TileHeight=“250”
TileWidth=“250” UnitsPerPixel=“7.315508” Width=“0” ZoomFactor=“1.000000”
ZoomLevel=“0”/>
    <TileLevel Height=“0” OriginX=“0” OriginY=“0” TileHeight=“250”
TileWidth=“250” UnitsPerPixel=“3.657754” Width=“0” ZoomFactor=“2.000000”
ZoomLevel=“1”/>
    </TileSet>
    <GeometrySet>
      <Geometry Id=“98” Type=“Point2d”>
      <Point2d Type=“p1” X=“0” Y=“0”/>
      <color Type=“stroke” Value=“#ffffff”/>
      </Geometry>
      <Geometry Id=“99” Type=“Line2d”>
      <Point2d Type=“Start” X=“0” Y=“0”/>
      <Point2d Type=“End” X=“200” Y=“300”/>
      <color Type=“stroke” Value=“#ffffff”/>
      </Geometry>
      <Geometry Id=“100” Type=“Rect”>
      <Point2d Type=“Min” X=“0” Y=“0”/>
      <Point2d Type=“Max” X=“200” Y=“300”/>
      <Color Type=“Stroke” Value=“#ffffff”/>
      <Color Typer=“Fill” Value=“#00ff00”/>
      </Geometry>
      <Geometry Id=“101” Type=“Rect”>
      <Point2d Type=“Min” X=“0” Y=“200”/>
      <Point2d Type=“Max” X=“400” Y=“300”/>
      <Color Type=“Stroke” Value=“#ffffff”>
      </Geometry>
      <Geometry Id=“102” Type=“Ellipse”>
      <Point2d Type=“Min” X=“0” Y=“0”/>
      <Point2d Type=“Max” X=“200” Y=“300”/>
      <Color Type=“Stroke” Value=“#ffffff”>
      </Geometry>
    </GeometrySet>
    <AnnotationSet>
      <Annotation Id=“34”>
      <RichText>
        <![CDATA[annotation-text]]>
      </RichText>
      <Geometry Type=“Point”>
        <Point2d X=“0” Y=“0”/>
      </Geometry>
    </Annotation>
    <Annotation Id=“27”>
      <RichText>
        <![CDATA[annotation-text]]>
      </RichText>
      <Geometry Type=“Rectangle”>
        <Point2d Type=“Min” X=“0” Y=“0”/>
        <Point2d Type=“Max” X=“400” Y=“300”/>
      </Geometry>
    </Annotation>
    <Annotation Id=“56984”>
      <RichText>
        <![CDATA[annotation-text]]>
      </RichText>
      <Geometry Type=“Ellipse”>
        <Point2d Type=“Min” X=“0” Y=“0”/>
        <Point2d Type=“Max” X=“400” Y=“300”/>
      </Geometry>
    </Annotation>
    </AnnotationSet>
  </Layout>
  </LayoutSet>
</CADXML>
```

### Additional Features

ALR files are not reserved for just handling AutoCAD layers. They can also be used to handle any last minute image processing before the user views the encoded raster (PNG, GIF, ect). Additional uses for the ALR file format are described as follows.

### AutoCAD Block References

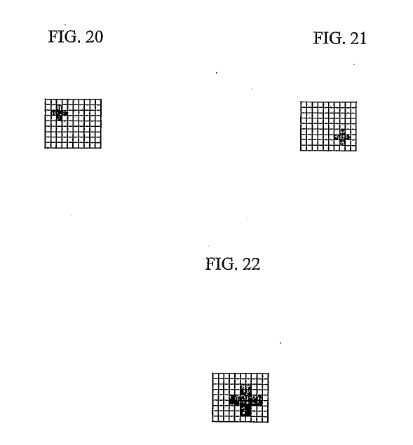

AutoCAD has a concept of “blocks”, a grouping of primitives into a user-defined entity. This entity can later be referenced many times in a drawing. These references are referred to as “block references”. A block reference could be viewed as a stamp that the user places in the drawing many times. Since block references are on a single layer, one can group the pixel data in the ALR files according to blocks. This permits one to move the pixel data to other positions in the ALR file. As a result, the user can move the block references on the fly in the diagram. In addition the system can provide a list of the user's blocks in a tool bar that the user can drag and drop onto the diagram, thus adding new blocks to the diagram. Primitive data will also be in order in the ALR file, allowing smaller edits to take place in the diagram as well. An example of the procedure of moving a block is outlined below with reference to FIGS. 20, 21 and 22.

In FIG. 20 the block is a cross, viewed a 9×9 pixel image. The ALR file can store the data in a raw format that would allow one to perform image transformations before the data went to the browser as an encoded PNG, GIF or JPEG file. Thus a user could grab and perform a “drag” or translate operation on the FIG. 20 image and those changes could be used to modify the pixel data to that shown in FIG. 21. Other standard image transformation also apply to what has been described. Another example would be a process that scaled the image.

In the example shown in FIG. 22 the cross has been translated and scaled from the original example. Other transformations that could be applied are rotations and flips. The information that the ALR provides back to the user is purely visual, but this information can also be used to transform the objects of the original AutoCAD file to reflect the user's changes in the visual representation, thus allowing for geometric elements to persist back into the original drawing.

### Color Modifications

Another example of how ALR files may be used as a last minute source of changes is in color modifications. A client may want to display the color drawing in black and white or other formats that they can print. Since ALR color data can be changed on the fly before presentation, there is an opportunity to modify the color data before it is presented to the user. This includes making the solid background color bit “white” and changing all of the geometry to “black” for simple printing. In addition one can grey-scale original colors so that the contrast of the original color is preserved in the final image. Other modifications that can be made are as simple as the user re-assigning colors that they have chosen in AutoCAD.

Thus the present invention permits anyone with a web browser to view, zoom, markup, and edit CAD files without special software tools. The solution has been made feasible by calculating and serving rasterized PNG (portable network graphic) files that are visible to the user.

The ALR file format according to the invention has particularly useful applications through the addition of additional data members or fields associated with each pixel, namely fields for R, G, B, transparency (“T”), elevation (“E”) and object identity (“O”). Each “member” of the data set [RGBTEO] is composed of a discrete set of bytes which is set prior to the creation of the ALR file. For example, for a particular ALR file each member might be set to;

R=two bytes
G=two bytes
B=two bytes
Transparency=one byte
Elevation=two bytes
ObjectID=three bytes

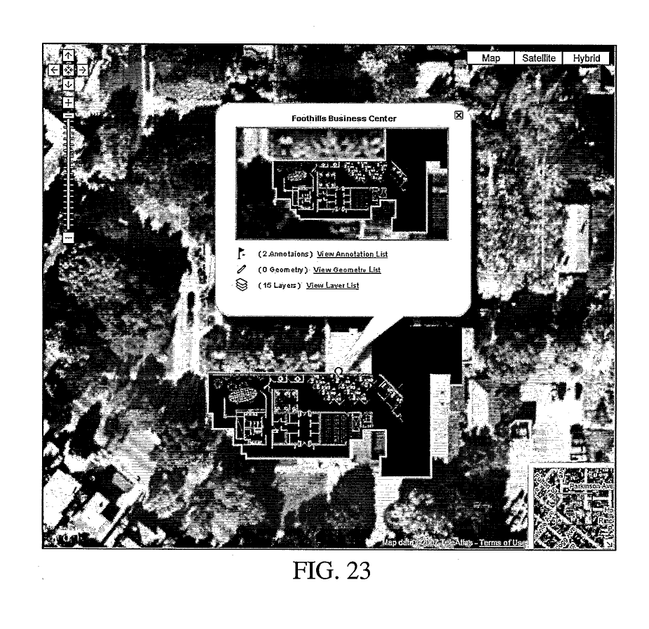

Therefore each pixel in the ALR file would have a 12 byte value. As described further below, the RGB values define the colour of the pixel in the usual way, the transparency value defines the transparency or alpha value of transparency. The transparency value permits the CAD drawing to be deployed on maps such as Google Maps. The CAD drawing sits as another layer over the Google map with everything outside the drawing being transparent. See FIG. 23. The CAD file can be combined with the Google Map file in the same way Google Mashups are achieved to merge other image files with Google files currently. In this way CAD files can be displayed to the client when particular locations on the map are clicked, as further described below, in the same way that pushpins are used currently, with the advantage that the CAD file displayed to the client will have the annotations, object identification and other features of the ALR files as described herein.

The elevation value is used to indicate a pixel's value above or below sea level so that the elevation can be quickly accessed to draw a 3D version of an ALR file should the need arise. That way for example, if one drew a sink from the second floor of a house, it would already be known that it is 150 feet above sea level and when the sink is drawn from the third floor, it already knows that it is 160 feet above sea level.

Google Maps takes vector map information and satellite photos and renders all of the information to tile sets that serve out quickly and are compatible with most browsers. By serving out map data in this fashion, Google Maps has created a product that can view the entire surface of the world with fine image resolution to virtually any browser without having to install any software at the client end. While in this way high value content is served in a simple fashion, the problem arises because the Google Map image tiles are just images and the structures drawn on the tiles during the rasterization process have lost their original object identities and have become just pixel color values.

To get that information back into the map, currently maps offered in an Ajax fashion like Google Maps provide the user with the ability to use “pushpins” or Markers to attach some information to the map at that point (longitude and latitude) but the map tiles are still a simple bitmap image with no further inherent information available. In addition, some Ajax maps allow the user the ability to draw “hotspots” on top of the map tiles using a vector drawing method like SVG (Firefox browser) or VML (Internet Explorer) so that when the user clicks on it, they are redirected to other information. While it might be possible to draw many of these hotspots on a map to indicate places of business and events, it becomes impractical after the addition of just a few vector hotspots as the added computational overhead becomes prohibitive. While this approach is functional at the basic level, there has previously been no way to, in a computationally efficient manner, keep the original object intelligence with the map image tiles being served out.

Since most of the map information starts out as vector information to begin with, the present method preserves the association between the non-geometric data and the vector data that is rasterized into a map image tile. It does this by adding the ObjectID data member to the ALR file for each pixel. The ObjectID is a string which comes from the original CAD file to uniquely define an object in the original drawing. It is thereby possible to directly associate a map image tile pixel with the specific vector object associated with the pixel in the original CAD or GIS file. Thus every pixel in the ALR file is mapped back to an object in the original CAD diagram. When the ALR file is created, the original ObjectID of the object that is being rasterized is recorded, thus maintaining that association. In this way all of the object's information is coupled to the pixel that is sent to the user.

This gives one the ability to select, search and highlight individual objects on the map image tiles as if one were using a vector object diagram.

Select—When the user clicks on an Map image tile pixel, a “hit test” is used to look up the associated object identification number from the ALR file. Once one has this ObjectID number, one can quickly find all of the rest of the pixels with the same ObjectID number. One can then produce a PNG or JPG file created with just pixels belonging to the same ObjectID colored in an illustrative fashion. When placed on top of the original map image tile the user clicked, it will appear that the user has “highlighted” the selected object.

Search—A user may type into a map search a search term such as “Neil's Restaurant, Yaletown” and the search engine runs that through the database and finds an ObjectID number for the original drawing object that represented the object in question “Neil's Restaurant, Yaletown”. The system can then again find all of the pixels with the matching ObjectID number in the ALR file and produce a “Highlight” image to display on top of the relevant map image tile to display the result of the search in a visual fashion.

Because the non-geometric information associated with each pixel on the map image tile is retained, one can create an object oriented “information layer” on top of the map image tile. This means that business and community can manage these ObjectIDs to disseminate further information to the user and display other related objects on the map that are relevant. In this fashion, the “last mile” of the map zoom is introduced in that spatially organized objects on the map have been created and those ObjectID'd pixels can then be enriched with metadata, links, GeoRSS, Calendar links etc. It also means that the non-geographic information associated with each map pixel can evolve independently without having to disturb and redraw/retile the map image tiles

This last feature lends itself particularly well to map advertising, where the advertisement can be attached to a specific object on the map and not as a simple pushpin popup associated only with a lat/long coordinate. This reduces ambiguity in that previously the user may have seen several pushpin map advertisements clustered around, for example, a shopping mall with each pushpin having no relevant association with the location of the store within the mall. Further queries are possible with the present method beyond the current zoom bar limitations in that one can display objects within objects like the stores within the mall that was not impossible with just a simple map image tile.

An ObjectID which is retrieved for a clicked pixel may have data or information stored in connection with it in a separate database which may be searched and retrieved, as noted above and exported back to the client in a file such as an SVG or CAD file. The database referred to above can also be used to store metadata, annotations and the like in respect of a particular object in the original CAD diagram. Thus a particular Object ID number, for example, can be tied to geometric and non-geometric data in the database. The database can have both annotations which are not tied to particular objects and annotations tied to specific objects in the original CAD diagram, say a pipe. In this way when a user clicks on a pixel, the user can be linked to annotations relevant to the object associated with that pixel, as shown in FIG. 23. Once the information is retrieved it can be presented to the client in their browser in several forms, such as a highlight, pop-up information window, textual information in a side window etc. Once the information is retrieved it can be exported from the system in a file format such as SVG, CAD, Excel to be used in another application.

While the present invention has been described with the client using client side browser software such as Internet Explorer, Safari and Firefox, the method also is useful with the client being displayed the graphics files using such applications as Flash Player and Silverlight, and the term “browser software” is defined herein to cover all suitable applications which permit the client to be displayed the graphics images over the internet.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of displaying and communicating a user's graphic file information to a client comprising:
a) the user selecting a graphic file to be communicated;
b) rendering each layer of the graphic file to thereby form a layer raster file containing raster information for each layer and draw order information;
c) converting said layer raster file to a file format which is readable by said client's browser software;
d) said client accessing a web site using internet client side browser software and requesting said converted file.

2. The method of claim 1 wherein a service provider has a web site accessible to said user and said client over the Internet, said user uploads said graphics file to said service provider, said service provider carries out said rendering and conversion steps, and said client is provided a URL to access the web site of said service provider and request and be served files in a format which can be displayed by standard browser software.

3. The method of claim 1 wherein said client can annotate said files and said annotations can be saved and viewed by said user.

4. The method of claim 1 wherein said user selects rendering options to be applied to said selected graphic file prior to said rendering step.

5. The method of claim 1 wherein said rendering options are selected from the group consisting of height and width of the image, zoom factor, the number of times the zoom can be activated in one direction, whether the image will have a border, and whether anti-aliasing will apply.

6. The method of claim 1 wherein said graphic file is rendered by rendering each layer of said graphic file while storing the drawing order information for the data in each layer, and then sorting the data for all layers by drawing order values.

7. The method of claim 1 wherein said layer raster file is converted to a file format selected from the group consisting of .png, .jpeg and .gif

8. The method of claim 1 wherein said layer raster file comprises a field for each pixel identifying the object in said graphic file associated with said pixel.

9. The method of claim 8 wherein said layer raster file further comprises a field for each pixel identifying the transparency value associated with said pixel.

10. The method of claim 9 wherein said layer raster file comprises a field for each pixel identifying the elevation value associated with said pixel.

11. The method of claim 1 further comprising providing an associated annotation file with said layer raster file to hold metadata concerning said graphic file.

12. The method of claim 11 wherein said associated annotation holds geometric or non-geometric metadata concerning said graphic file.

13. The method of claim 11 wherein said associated annotation holds annotations concerning said graphic file.

14. The method of claim 9 wherein when said client selects an object from a graphic file by clicking on an image tile pixel, determining the associated object identification number from the layer raster file, locating other pixels with the same object identification number and displaying said pixels with the same object identification number.

15. The method of claim 9 wherein when said client searches for an object in a graphic file by entering a search term, locating the object identification number associated with said search term from a database, locating pixels with the same object identification number and displaying said pixels with the same object identification number.

16. The methods of claims 14 or 15 wherein said graphic file is a map and said pixels are displayed on top of the map image.

17. The methods of claims 14 or 15 wherein object identification number which is retrieved for a clicked pixel is associated with data stored in connection with it in a database.

18. The methods of claims 14 or 15 wherein Level Of Detail is used to reduce the number of objects being drawn at a current viewing level.

19. A system for using the Internet to permit a user to display to a plurality of clients, each having a computer with a web browser which can access a web site maintained by a server accessible over the Internet, said user's graphic file information comprising:
a) computer-implemented means for the user to select a graphic file to be communicated;
b) computer-implemented means for rendering each layer of the graphic file to thereby form a layer raster file containing raster information for each layer and draw order information;
c) computer-implemented means for converting said layer raster file to a file format which is readable by said client's browser software;
d) said client accessing a web site using said browser software and requesting said converted file.

20. The system of claim 19 wherein said graphic file is rendered by rendering each layer of said graphic file while storing the drawing order information for the data in each layer, and then sorting the data for all layers by drawing order values.

21. The system of claim 19 further comprising a service provider having a web site accessible to said user and said clients over the Internet, whereby said user uploads said graphics file to said service provider, said service provider carries out said rendering and conversion, and said client is provided a URL to access the web site of said service provider and request and be served files in a format which can be displayed by standard browser software.
